(19) United States
(12) Patent Application Publication
(10) Pub. No.: US 2026/0213948 A1
(43) Pub. Date: Jul. 23, 2026

(54) CONSOLIDATED PROTOCOL FOR DECENTRALIZED IDENTIFIER COMMUNICATIONS

(71) Applicant: American Express Travel Related Services Company, Inc., New York, NY (US)

(72) Inventors: Andrew Lei, Brooklyn, NY (US); Mukund Shankar SimhaRaghu, Glendale, AZ (US); Andras L. Ferenczi, Scottsdale, AZ (US)

(21) Appl. No.: 19/571,969

(22) Filed: Mar. 19, 2026

Related U.S. Application Data
(62) Division of application No. 18/237,043, filed on Aug. 23, 2023.

(51) Int. Cl. H04L 9/32; H04L 9/08

(52) U.S. Cl. CPC H04L 9/3226; H04L 9/0825; H04L 9/3247

(57) ABSTRACT

Disclosed are various embodiments for consolidated protocols for decentralized identifier communications (DIDComm). In various embodiments, an issuer can receive a secure connection request and request for a credential from a holder. The issuer can then send a second packet comprising an acceptance of the secure connection request to the holder and subsequently send a verifiable credential after establishing the secure connection. The holder can simultaneously send an acknowledgement for setting up the secure connection and receiving the verifiable credential. The holder can request a second secure connection with a verifier. After establishing the second secure connection, the holder can send a verifiable presentation or the verifiable credential to the verifier, which the verifier can verify.

### CROSS-REFERENCE TO RELATED APPLICATIONS

This application is a divisional of, claims priority to, and the benefit of, co-pending U.S. application Ser. No. 18/237,043, entitled “CONSOLIDATED PROTOCOL FOR DECENTRALIZED IDENTIFIER COMMUNICATIONS” and filed on Aug. 23, 2023, the entire contents of which are incorporated herein by reference as if set forth in its entirety

### BACKGROUND

Decentralized Identifiers (DIDs) are globally unique identifiers that enable individuals, organizations, or things to have verifiable and self-owned digital identities. Verifiable credentials are data structures that represent claims about some attribute, qualification, or achievement related to a specified DID. Messaging protocols can be used to securely and privately communicate verifiable credentials and DIDs among interested parties. To decrease latency, a need exists for messaging protocols to become more streamlined while still maintaining data security.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart illustrating one example of functionality implemented as portions of an application executed in an issuer computing environment in the network environment of FIG. 1 according to various embodiments of the present disclosure.

FIG. 3 is a flowchart illustrating one example of functionality implemented as portions of an application executed in a holder computing environment in the network environment of FIG. 1 according to various embodiments of the present disclosure.

FIG. 4 is a flowchart illustrating one example of functionality implemented as portions of an application executed in a verifier computing environment in the network environment of FIG. 1 according to various embodiments of the present disclosure.

FIGS. 5A and 5B are a sequence diagrams illustrating interactions between various components of the network environment of FIG. 1 according to various embodiments of the present disclosure.

FIG. 6 is a drawing of a network environment according to various embodiments of the present disclosure.

FIG. 7 is a flowchart illustrating one example of functionality implemented as portions of an application executed in an issuer computing environment in the network environment of FIG. 6 according to various embodiments of the present disclosure.

FIG. 8 is a flowchart illustrating one example of functionality implemented as portions of an application executed in an intermediary computing environment in the network environment of FIG. 6 according to various embodiments of the present disclosure.

FIG. 9 is a sequence diagram illustrating interactions between various components of the network environment of FIG. 6 according to various embodiments of the present disclosure.

### DETAILED DESCRIPTION

Disclosed are various approaches for consolidating protocols for decentralized identifier communications (DIDComm). DIDcomm is a messaging protocol specifically designed for secure and private communication between decentralized identifiers (DIDs) within a decentralized identity (DID) ecosystem. DIDs are globally unique identifiers that enable individuals, organizations, or things to have verifiable and self-owned digital identities. DIDcomm provides a standardized framework for exchanging messages and establishing secure channels of communication between DIDs, allowing parties to securely share information, authenticate each other's identities, and protect the confidentiality and integrity of their communications. It emphasizes privacy, security, and interoperability in the context of decentralized identity systems. DIDcomm can be implemented in various ways, including as a network layer protocol and/or an application layer protocol. In various examples, the DIDcomm can be implemented using various standards, such as a version of the Decentralized Identity Foundation (DIF) DIDcomm standard.

However, existing specifications of DIDcomm require that a secure connection be established between two devices before an issuance of a verifiable credential or a verification of a verifiable presentation can be performed. Although this is similar to other secure messaging protocols (e.g., TLS/SSL, etc.), such that a secure connection is required before secure information is shared, this process can be time consuming and cause significant latency in the data communications between devices. Disclosed are various approaches for consolidating steps in the protocol for DIDcomm that decrease latency while maintaining security.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

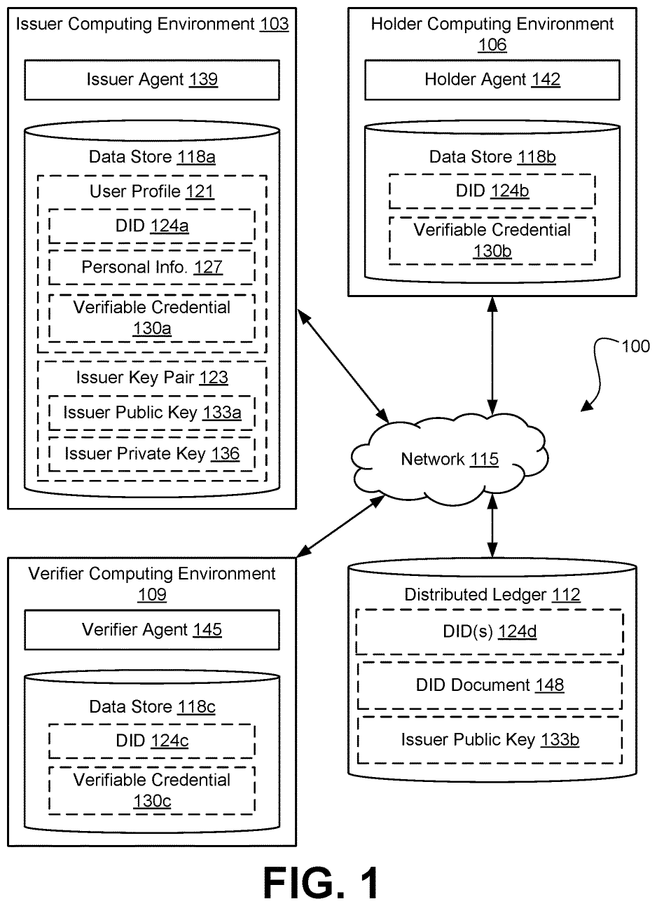

With reference to FIG. 1, shown is a network environment 100 according to various embodiments. The network environment 100 can include an issuer computing environment 103, a holder computing environment 106, a verifier computing environment 109, a distributed ledger 112, each of which can be in data communication with each other via a network 115.

The network 115 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 115 can also include a combination of two or more networks 115. Examples of networks 115 can include the Internet, intranets, extranets, virtual private networks (VPNs), and similar networks.

The issuer computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

In at least one embodiment, the issuer computing environment 103 can employ a plurality of computing devices that can be arranged in one or more server banks or computer banks or other arrangements. Such computing devices can be located in a single installation or can be distributed among many different geographical locations. For example, the issuer computing environment 103 can include a plurality of computing devices that together can include a hosted computing resource, a grid computing resource, or any other distributed computing arrangement. In some cases, the issuer computing environment 103 can correspond to an elastic computing resource where the allotted capacity of processing, network, storage, or other computing-related resources can vary over time.

In at least another embodiment, the issuer computing environment 103 can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a video game console, or other devices with like capability. The issuer computing environment 103 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the issuer computing environment 103 or can be connected to the issuer computing environment 103 through a wired or wireless connection.

Various data can be stored in a data store 118a that is accessible to the issuer computing environment 103. The data store 118a can be representative of a plurality of data stores 118b, which can include relational databases or non-relational databases such as object-oriented databases, hierarchical databases, hash tables or similar key-value data stores, as well as other data storage applications or data structures. Moreover, combinations of these databases, data storage applications, and/or data structures can be used together to provide a single, logical, data store. The data stored in the data store 118a is associated with the operation of the various applications or functional entities described below. This data can include a user profile 121, an issuer key pair 123, and potentially other data.

The user profile 121 can represent user data stored in association other usages of the issuer computing environment 103. For example, if the issuer computing environment 103 is an e-commerce platform, then the user profile 121 can include user data in relation to its e-commerce platform's usage. Additionally, the user profile 121 can include one or more DIDs 124a (generically as 124), personal information 127 and verifiable credentials 130a (generically as 130)

The DID 124 can correspond to an identifier that enables verifiable, decentralized digital identity of a subject (e.g., person, organization, thing, etc.). In some examples, the DID 124 can be used to represent the identity of a user, a holder computing environment 106, and other suitable subjects. In various examples, a DID 124 can include an address to a DID document 148 on a distributed ledger that includes information associated with the subject (e.g., a user, a holder computing environment 106, etc.). DID documents 148 could be hosted on any computing environment, such as the issuer computing environment 103, holder computing environment 106, the verifier computing environment 109, or any other computing environment. In such a situation, the DID document 148 could be shared peer-to-peer. In various examples, the DID 124 can be implemented using various standards, such as a version of the World Wide Web Consortium's (W3C's) Decentralized Identifier (DID) standard.

The personal information 127 can represent personal data associated with a user, name, address, contact information, transaction information (e.g., transaction confirmation, payment instruments, etc.), healthcare information, and other suitable user data. The personal information 127 can be used to identify a person or an entity associated with a DID 124.

A verifiable credential 130 (often abbreviated to VC) can represent a digital credential that has been issued by a third party, such as the issuer computing environment 103. The verifiable credential 130 can be used to derive verifiable presentations, which are tamper-evident presentations encoded in such a way that the source of the data can be trusted after a process of verification. The verifiable presentations are synthesized in such a way that the verifiable credential 130 cannot be recreated from the verifiable presentation alone. Verifiable credentials 130 and verifiable presentations can be implemented using various standards, such as a version of the World Wide Web Consortium's (W3C's) Decentralized Identifier (DID) standard.

The issuer key pair 123 can represent a pair of asymmetric cryptographic keys comprising an issuer public key 133a (generically as 133) and issuer private key 136. The issuer public key can be used to cryptographically encrypt messages. The issuer private key 136 can be used to cryptographically decrypt messages that have been encrypted by the issuer public key 133. The issuer private key 133 can be used to cryptographically sign various items, such as verifiable credentials 130 or various messages. The issuer public key 133 can be used to cryptographically verify that something (e.g., a verifiable credential 130, a message, etc.) is cryptographically signed by the issuer private key 136.

Various applications or other functionality can be executed in the issuer computing environment 103. The components executed on the issuer computing environment 103 include an issuer agent 139, and other applications, services, processes, systems, engines, or functionality not discussed in detail herein.

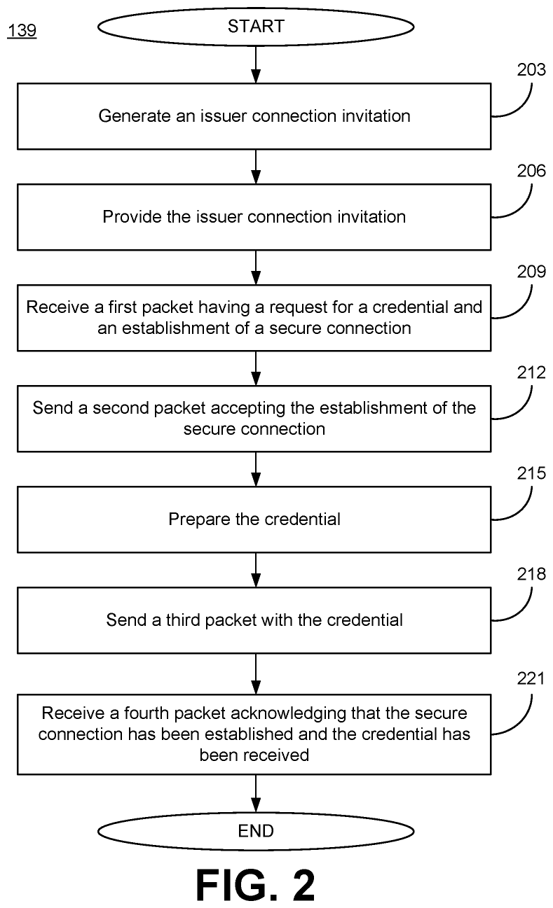

The issuer agent 139 can be executed to perform various actions. For instance, the issuer agent 139 can generate an issuer connection invitation. The issuer agent 139 can then provide the connection invitation to a holder agent 142. Then, the issuer agent 139 can receive a request for verifiable credential(s) 130 and/or a request to establish a secure connection between the holder agent 142 and the issuer agent 139. The issuer agent 139 can then send a response that establishes the secure connection between the holder agent 142 and the issuer agent 139. The issuer agent 139 can then prepare the verifiable credential 130. In some embodiments, requested verifiable credential(s) 130 might not have already been generated, and thus the issuer agent 139 must generate the verifiable credential(s) 130. In other embodiments, verifiable credential(s) 130 can be stored in a data store 118a. Once each of the verifiable credential(s) 130 has been generated or retrieved, the verifiable credential(s) 130 can be signed by the issuer private key 136. The issuer agent 139 can send the verifiable credential(s) 130. The issuer agent 139 can also receive an acknowledgement that the secure connection has been established and/or the verifiable credential(s) has/have been received. Further discussion on the actions that the issuer agent 139 can be executed to perform will be discussed in FIGS. 2, 5A, 7, and 9.

The holder computing environment 106 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

In at least one embodiment, the holder computing environment 106 can employ a plurality of computing devices that can be arranged in one or more server banks or computer banks or other arrangements. Such computing devices can be located in a single installation or can be distributed among many different geographical locations. For example, the holder computing environment 106 can include a plurality of computing devices that together can include a hosted computing resource, a grid computing resource, or any other distributed computing arrangement. In some cases, the holder computing environment 106 can correspond to an elastic computing resource where the allotted capacity of processing, network, storage, or other computing-related resources can vary over time.

In at least another embodiment, the holder computing environment 106 can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a video game console, or other devices with like capability. The holder computing environment 106 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the holder computing environment 106 or can be connected to the holder computing environment 106 through a wired or wireless connection.

Various data can be stored in a data store 118b that is accessible to the holder computing environment 106. The data store 118b can be representative of a plurality of data stores 118b, which can include relational databases or non-relational databases such as object-oriented databases, hierarchical databases, hash tables or similar key-value data stores, as well as other data storage applications or data structures. Moreover, combinations of these databases, data storage applications, and/or data structures can be used together to provide a single, logical, data store. The data stored in the data store 118b is associated with the operation of the various applications or functional entities described below. This data can include one or more DIDs 124b, verifiable credentials 130b, and potentially other data. DIDs 124b can be otherwise identical to the DIDs 124a, except stored in data store 118b rather than data store 118a. Verifiable credentials 130b can be otherwise identical to the verifiable credentials 130a, except stored in data store 118b rather than data store 118a.

Various applications or other functionality can be executed in the holder computing environment 106. The components executed on the holder computing environment 106 include holder agent 142, and other applications, services, processes, systems, engines, or functionality not discussed in detail herein.

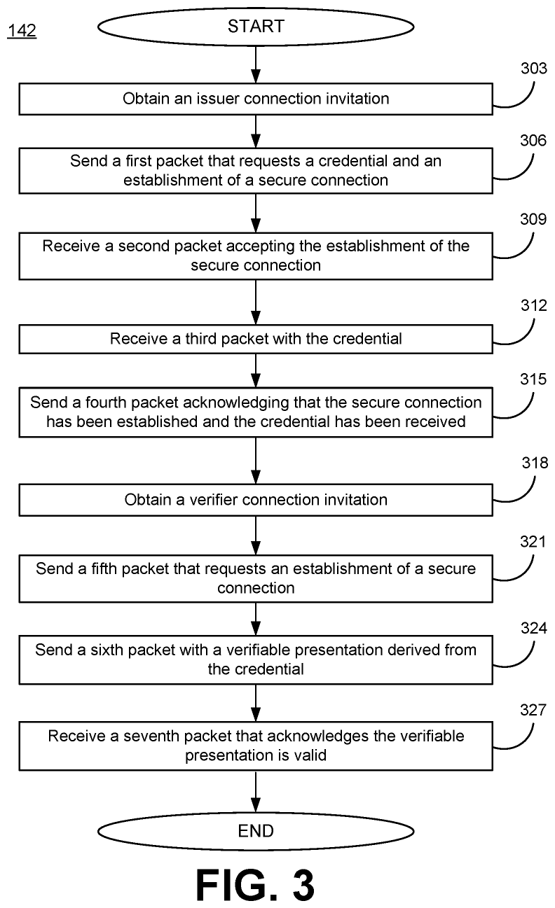

The holder agent 142 can be executed to perform various actions. For instance, the holder agent 142 can obtain an issuer connection invitation from an issuer agent 139. The holder agent 142 can send a request for verifiable credential(s) 130 and/or requests that a secure connection be established. The holder agent 142 can receive an acknowledgement of the secure connection. The holder agent 142 can also receive verifiable credential(s) 130. The holder agent 142 can also send an acknowledgement that the secure connection has been established and/or that the verifiable credential(s) 130 has/have been received. The holder agent 142 can also obtain a verifier connection invitation from a verifier agent 145. The holder agent 142 can also send requests to establish a secure connection between the holder agent 142 and the verifier agent 145. The holder agent 142 can send verifiable presentation(s) derived from the verifiable credential(s) 130b. The holder agent 142 can receive an acknowledgement that the verifiable presentation(s) derived from the verifiable credential(s) 130b is/are valid. Further discussion on the actions that the holder agent 142 can be executed to perform will be discussed in FIGS. 3, 5A, 5B, and 9.

The verifier computing environment 109 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

In at least one embodiment, the verifier computing environment 109 can employ a plurality of computing devices that can be arranged in one or more server banks or computer banks or other arrangements. Such computing devices can be located in a single installation or can be distributed among many different geographical locations. For example, the verifier computing environment 109 can include a plurality of computing devices that together can include a hosted computing resource, a grid computing resource, or any other distributed computing arrangement. In some cases, the verifier computing environment 109 can correspond to an elastic computing resource where the allotted capacity of processing, network, storage, or other computing-related resources can vary over time.

In at least another embodiment, the verifier computing environment 109 can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a video game console, or other devices with like capability. The verifier computing environment 109 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the verifier computing environment 109 or can be connected to the verifier computing environment 109 through a wired or wireless connection.

Various data can be stored in a data store 118b that is accessible to the verifier computing environment 109. The data store 118b can be representative of a plurality of data stores 118b, which can include relational databases or non-relational databases such as object-oriented databases, hierarchical databases, hash tables or similar key-value data stores, as well as other data storage applications or data structures. Moreover, combinations of these databases, data storage applications, and/or data structures can be used together to provide a single, logical, data store. The data stored in the data store 118b is associated with the operation of the various applications or functional entities described below. This data can include one or more DIDs 124c, verifiable credentials 130c, and potentially other data. DIDs 124c can be otherwise identical to the DIDs 124a and DIDs 124b, except stored in data store 118c rather than data store 118a or data store 118b. Verifiable credentials 130c can be otherwise identical to the verifiable credentials 130a or verifiable credentials 130b, except stored in data store 118c rather than data store 118a or data store 118b.

Various applications or other functionality can be executed in the verifier computing environment 109. The components executed on the verifier computing environment 109 include verifier agent 145, and other applications, services, processes, systems, engines, or functionality not discussed in detail herein.

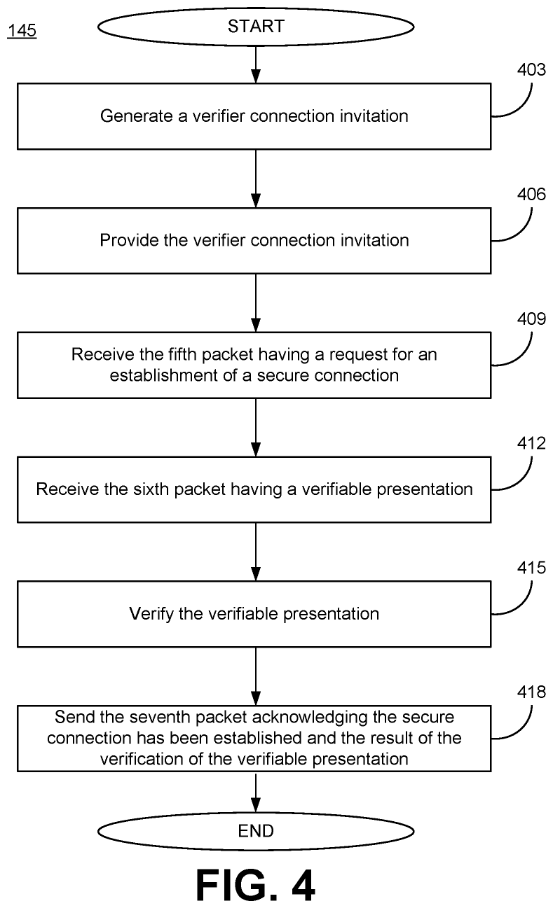

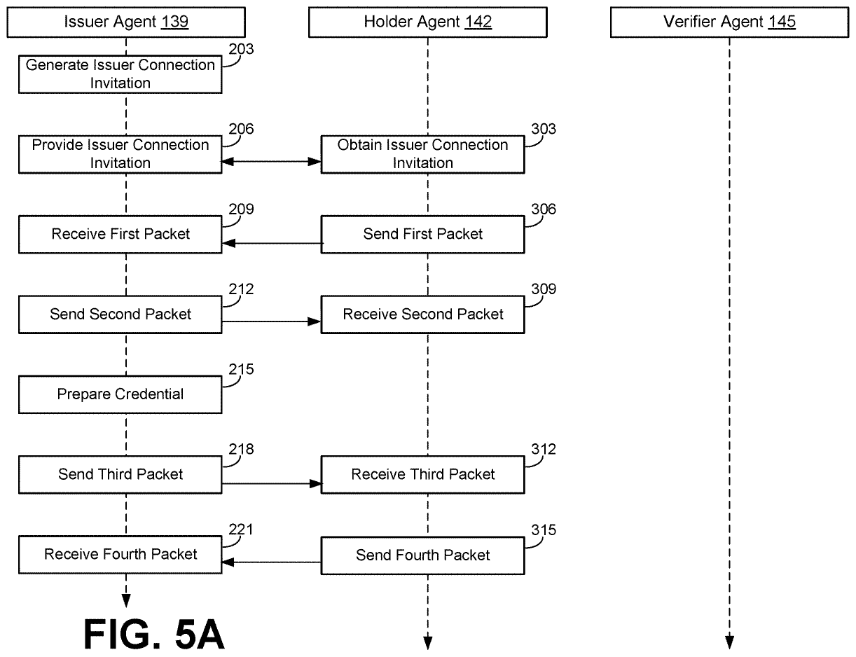

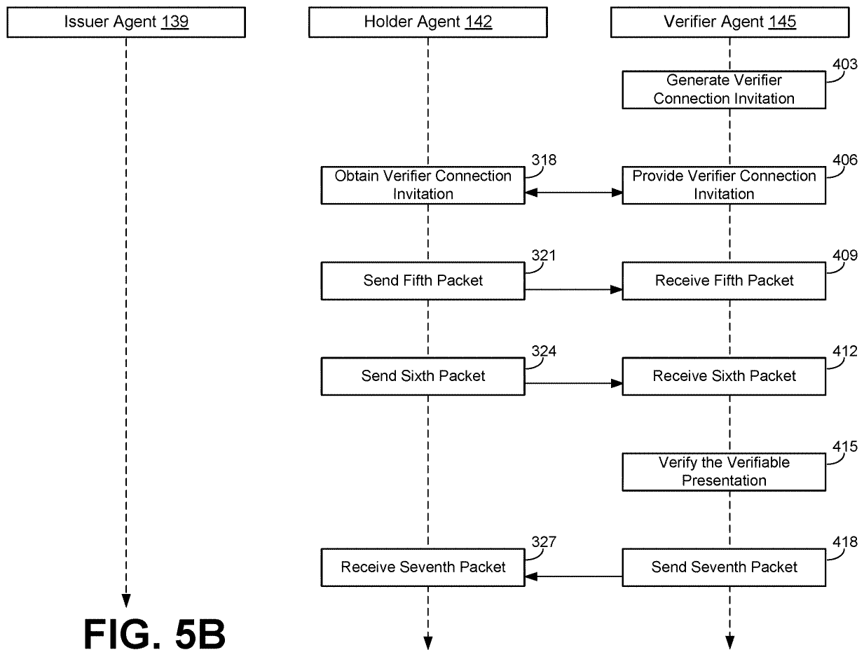

The verifier agent 145 can be executed to perform various actions. For example, the verifier agent 145 can generate a verifier connection invitation. The verifier agent 145 can also provide the verifier connection invitation to another agent, such as a holder agent 142. The verifier agent 145 can receive a request to establish a secure connection between the verifier agent 145 and the holder agent 142. The verifier agent 145 can also receive a verifiable presentation derived from a verifiable credential 130. The verifier agent 145 can also verify the verifiable presentation that was derived from the verifiable credential 130. The verifier agent 145 can also send an acknowledgement that the secure connection has been established and/or a result of verifying the verifiable presentation to the holder agent 142. Further discussion on the actions that the verifier agent 145 can be executed to perform will be discussed in FIGS. 4 and 5B.

The distributed ledger 112 can represent one or more synchronized, eventually consistent, data stores spread across multiple nodes in different geographic or network locations. Each node in the distributed ledger 112 can contain a replicated copy of the distributed ledger 112, including all data stored in the distributed ledger 112. Records of transactions involving the distributed ledger 112 can be shared or replicated using a peer-to-peer network connecting the individual nodes that form the distributed ledger 112. Once a transaction or record is recorded in the distributed ledger 112, it can be replicated across the peer-to-peer network until the record is eventually recorded with all nodes.

The distributed ledger 112 can include DID(s) 124d, DID document(s) 148, one or more public keys, including the issuer public key 133b, and other suitable data. DIDs 124d can be otherwise identical to the DIDs 124a, DIDs 124b, and DIDs 124c, except stored on the distributed ledger 112 rather than data store 118a, data store 118b, or data store 118c, respectively. In various examples, a DID 124d can correspond to an address to a DID document 148 that includes information associated with a subject (e.g., user, transaction, device, etc.). For example, the DID document 148 can include a set of data describing the subject and can include various information (e.g., cryptographic keys) that can be used to authenticate the subject. In at least one example, the DID document 148 can include various public keys, such as the issuer public key 133b. In various examples, the DID 124d and the DID document 148 can be implemented using various standards, such as the World Wide Web Consortium's (W3C's) Decentralized Identifier (DID) standard. The issuer public key 133b can be otherwise identical to the issuer public key 133a, except stored in distributed ledger 112 rather than data store 118a.

Referring next to FIG. 2, shown is a flowchart that provides one example of the operation of a portion of the issuer agent 139. The flowchart of FIG. 2 provides merely an example of the many different types of functional arrangements that can be employed to implement the operation of the depicted portion of the issuer agent 139. As an alternative, the flowchart of FIG. 2 can be viewed as depicting an example of elements of a method implemented within the network environment 100.

Beginning with block 203, the issuer agent 139 can generate an issuer connection invitation. The issuer connection invitation can include information about the issuer agent 139, such as an address (e.g., an IP address, etc.) and/or a DID that can identify the issuer agent 139. By including the address and/or a DID, another device which obtains the issuer connection invitation can identify and communicate with the issuer agent 139. The connection information can be used to establish a secure connection between the issuer computing environment 103 and any other computing device, such as a holder computing environment 106.

The issuer connection invitation can also include an offer to generate a verifiable credential 130. The offer to generate the verifiable credential 130 can include offer terms and conditions. For example, an issuer agent 139 for an e-commerce platform can provide an offer to existing customers to generate a verifiable credential 130 for customers who have purchased certain products or services. The generated issuer connection invitation can take the form of an address (e.g., a web address/link, etc.), a matrix barcode (e.g., a Quick Response (QR) code), a barcode, or any other form of message presentation that can be transferred or received between two devices. In at least one embodiment, the issuer connection invitation is a network accessible document that can be identified by a link. For example, the issuer connection invitation could be stored on a distributed ledger 112 as a DID document 148 which can be identified by a DID 124d.

Next, at block 206, the issuer agent 139 can provide the issuer connection invitation to a holder agent 142. In at least one embodiment, the issuer connection invitation can be a matrix barcode (e.g., a QR code) or a barcode. In such an embodiment, the issuer agent 139 can direct the issuer computing environment 103 to display the matrix barcode and/or the barcode for consumption by another computing device. In another embodiment where the issuer connection invitation can be a matrix barcode and/or a barcode, such a matrix bar code and/or barcode can be sent to another computing device. In at least another embodiment, the issuer agent 139 can send the issuer connection invitation to the second computing device. In some embodiments, the issuer connection invitation can be sent over e-mail, SMS messaging, or other messaging protocols. In some embodiments, the issuer connection invitation can be stored on the distributed ledger 112 as a DID document 148. As DID documents 148 can be publicly accessible and they can be referenced by the corresponding DID 124, another computing device can access the issuer connection invitation by retrieving the issuer connection invitation from the distributed ledger.

Continuing to block 209, the issuer agent 139 can receive a first packet having a request for a verifiable credential 130 and a request to establish a secure connection. The first packet can include both the request for the verifiable credential 130 and the request to establish the secure connection as a single packet rather than two distinct packets. The issuer agent 139 can receive the first packet from a holder agent 142. The request to establish the secure connection can be a request to securely connect the holder agent 142 and the issuer agent 139 in a bi-directional secure connection. The request to establish the secure connection can include a cryptographic key that can be used to generate a shared secret between the holder agent 142 and the issuer agent 139. The request for the verifiable credential of the first packet can correspond to the offer to generate the verifiable credential that was provided by the issuer connection invitation.

Next, at block 212, the issuer agent 139 can send a second packet that establishes the secure connection between the holder agent 142 and the issuer agent 139. In at least some embodiments, the issuer agent 139 can generate a shared secret based at least in part on a cryptographic key sent in the first packet. The shared secret is known by the holder agent 142 and the issuer agent 139, which can be used for encrypting and/or decrypting in the secure connection between the issuer agent 139 and the holder agent 142. Once the secure connection has been established, the second packet can acknowledge that the secure connection has been established. Doing so informs the holder agent 142 that the communications between the issuer agent 139 and the holder agent 142 are now secure.

Continuing to block 215, the issuer agent 139 can prepare the verifiable credential 130. In some embodiments, a verifiable credential 130 requested by the holder agent 142 might not exist, and thus the issuer agent 139 must generate a verifiable credential 130. In other embodiments, a verifiable credential 130 can be stored in a data store 118a. In such an embodiment, the issuer agent 139 can retrieve the verifiable credential 130 from the data store 118a. Once a verifiable credential 130 has been generated or retrieved, the verifiable credential 130 can be signed by the issuer private key 136. When the verifiable credential 130 is signed by the issuer private key 136, any other computing device will be able to verify the source of the verifiable credential 130 includes the issuer computing environment 103. In at least some embodiments, the verifiable credential 130 can be stored as verifiable credential 130a in data store 118a.

Next, at block 218, the issuer agent 139 can send a third packet to the holder agent 142 having the verifiable credential 130. The third packet can be sent in response to the secure connection between the issuer agent 139 and the holder agent 142 being established, as previously discussed at block 212, and/or when the issuer agent has prepared the verifiable credential 130, as previously discussed at block 215. The third packet can be sent over the secure connection between the issuer agent 139 and the holder agent 142. In at least some embodiments, the third packet can include a DID 124 that identifies the issuer agent 139. In such an embodiment, the DID 124 can include the issuer public key 133. By including the DID 124 that identifies the issuer agent 139, the holder agent 142 can further demonstrate the identity of the source that issued the verifiable credential 130.

At block 221, the issuer agent 139 can receive a fourth packet that acknowledges that the secure connection has been established and/or the verifiable credential 130 has been received. To prevent duplicative packets being sent, the combination of acknowledging both the secure connection has been established and the verifiable credential 130 acknowledgement can be sent as one single packet rather than two distinct packets. Once block 221 has completed, the flowchart of FIG. 2 can come to an end.

Referring next to FIG. 3, shown is a flowchart that provides one example of the operation of a portion of the holder agent 142. The flowchart of FIG. 3 provides merely an example of the many different types of functional arrangements that can be employed to implement the operation of the depicted portion of the holder agent 142. As an alternative, the flowchart of FIG. 3 can be viewed as depicting an example of elements of a method implemented within the network environment 100.

Beginning with block 303, the holder agent 142 can obtain the issuer connection invitation from the issuer agent 139. The issuer connection invitation can include information about the issuer agent 139, such as an address (e.g., IP address, etc.) and/or a DID that can identify the issuer agent 139. By including the address and/or a DID, another device which obtains the issuer connection invitation can identify and communicate with the issuer agent 139. The issuer connection invitation can also include an offer to generate a verifiable credential 130. The offer to generate the verifiable credential 130 can include offer terms and conditions. In at least one embodiment, the issuer connection invitation is a network accessible document that can be identified by a link. For example, the issuer connection invitation could be stored on a distributed ledger 112 as a DID document 148 which can be identified by a DID 124d.

In at least one embodiment, the holder agent 142 can receive the issuer connection invitation from the issuer agent 139 by scanning the issuer connection invitation as a Matrix barcode (e.g., a Quick Response (QR) code) or a barcode. In at least another embodiment, the holder agent 142 can request the issuer connection invitation from a specified web address. In at least another invitation, the issuer agent 139 can send the issuer connection invitation directly to the holder agent 142. The holder agent 142 can receive the issuer connection invitation over various forms of communication (e.g., SMS communication, e-mail communication, etc.) or over a direct connection over a network 115 (e.g., a Bluetooth connection, NFC sharing, etc.).

Next, at block 306, the holder agent 142 can send a first packet that requests a verifiable credential 130 and requests that a secure connection be established between the holder agent 142 and the issuer agent 139. The first packet can include both the request for the verifiable credential 130 and the request to establish the secure connection as a single packet rather than two distinct packets. The request to establish the secure connection can be a request to securely connect the holder agent 142 and the issuer agent 139 in a bi-directional secure connection. The request to establish the secure connection can include a cryptographic key that can be used to generate a shared secret between the holder agent 142 and the issuer agent 139. The request for the verifiable credential of the first packet can correspond to the offer to generate the verifiable credential that was provided by the issuer connection invitation. In some embodiments, the holder agent 142 can send the first packet in response to obtaining the issuer connection invitation and the offer to obtain the credential, as previously discussed in block 303.

Continuing to block 309, the holder agent 142 can receive a second packet accepting the establishment of the secure connection between the holder agent 142 and the issuer agent 139. In at least some embodiments, the second packet can be an acknowledgement that the secure connection has been established between the holder agent 142 and the issuer agent 139. In at least some embodiments, a shared secret can be derived from a cryptographic key sent in the first packet. The shared secret can be derived by the holder agent 142 and the issuer agent 139, which can be used for encrypting and/or decrypting messages in the secure connection between the issuer agent 139 and the holder agent 142.

Next, at block 312, the holder agent 142 can receive a third packet having the verifiable credential 130. The holder agent 142 can receive the third packet over the secure connection between the holder agent 142 and the issuer agent 139. In at least one embodiment, the holder agent 142 can receive the third packet in response to establishing the secure connection. In at least some embodiments, the third packet can include a DID 124 that identifies the issuer agent 139. In such an embodiment, the DID 124 can include the issuer public key 133. By including the DID 124 that identifies the issuer agent 139, the holder agent 142 can further demonstrate the identity of the source that issued the verifiable credential 130. In at least some embodiments, the verifiable credential 130 can be stored as verifiable credential 130b in data store 118b.

Continuing to block 315, the holder agent 142 can send a fourth packet acknowledging that the secure connection has been established and that the verifiable credential 130 has been received. To prevent duplicative packets being sent, the combination of acknowledging both the secure connection has been established and the verifiable credential 130 acknowledgement can be sent as one single packet rather than two distinct packets.

Next, at block 318, the holder agent 142 can obtain a verifier connection invitation from a verifier agent 145. The verifier connection invitation can include information about the verifier agent 145, such as an address (e.g., IP address, etc.) and/or a DID that can identify the verifier agent 145. By including the address and/or a DID, another device which obtains the verifier connection invitation can identify and communicate with the verifier agent 145. The generated issuer connection invitation can take the form of an address (e.g., a web address/link, etc.), a matrix barcode (e.g., a Quick Response (QR) code), a barcode, or any other form of message presentation that can be transferred or received between two devices. In at least one embodiment, the issuer connection invitation is a network accessible document that can be identified by a link. For example, the issuer connection invitation could be stored on a distributed ledger 112 as a DID document 148 which can be identified by a DID 124d.

In at least one embodiment, the holder agent 142 can receive the verifier connection invitation from the verifier agent 145 by scanning the verifier connection invitation as a matrix barcode or a barcode. In at least another embodiment, the holder agent 142 can request the verifier connection invitation from a specified web address. In at least another invitation, the verifier agent 145 can send the verifier connection invitation directly to the holder agent 142. The holder agent 142 can receive the verifier connection invitation over various forms of communication (e.g., SMS communication, e-mail communication, etc.) or over a direct connection over a network 115 (e.g., a Bluetooth connection, NFC sharing, etc.).

Continuing to block 321, the holder agent 142 can send a fifth packet that requests that a secure connection is established between the holder agent 142 and the verifier agent 145. The request to establish the secure connection can be a request to securely connect the holder agent 142 and the verifier agent 145 in a bi-directional secure connection. The request to establish the secure connection can include a cryptographic key that can be used to generate a shared secret between the holder agent 142 and the verifier agent 145. In some embodiments, the holder agent 142 can send the fifth packet in response to obtaining the verifier connection invitation, as previously discussed in block 318.

Next, at block 324, the holder agent 142 can send a sixth packet having a verifiable presentation derived from the verifiable credential 130. The verifiable credential 130 can be used to derive verifiable presentations, which are tamper-evident presentations encoded in such a way that the source of the data can be trusted after a process of verification. The verifiable presentations are synthesized in such a way that the verifiable credential 130 cannot be recreated from the verifiable presentation alone. Verifiable credentials 130 and verifiable presentations can be implemented using various standards, such as a version of the World Wide Web Consortium's (W3C's) Decentralized Identifier (DID) standard. In at least some embodiments, the verifiable presentation can be verified using a zero-knowledge proof.

At block 327, the holder agent 142 can receive a seventh packet that acknowledges that the verifiable presentation derived from the verifiable credential 130 is valid. To prevent duplicative packets being sent, the combination of acknowledging both the secure connection has been established and the verifiable presentation being verification result can be sent as one single packet rather than two distinct packets. Once block 327 has completed, the flowchart of FIG. 3 can come to an end.

Referring next to FIG. 4, shown is a flowchart that provides one example of the operation of a portion of the verifier agent 145. The flowchart of FIG. 4 provides merely an example of the many different types of functional arrangements that can be employed to implement the operation of the depicted portion of the verifier agent 145. As an alternative, the flowchart of FIG. 4 can be viewed as depicting an example of elements of a method implemented within the network environment 100.

Beginning with block 403, the verifier agent 145 can generate a verifier connection invitation. The verifier connection invitation can include information about the verifier agent 145, such as an address (e.g., IP address, etc.) and/or a DID that can identify the verifier agent 145. By including the address and/or a DID, another device which obtains the verifier connection invitation can identify and communicate with the verifier agent 145. The connection information can be used to establish a secure connection between the verifier computing environment 109 and any other computing device, such as a holder computing environment 106. The generated verifier connection invitation can take the form of an address (e.g., a web address/link, etc.), a matrix barcode (e.g., a Quick Response (QR) code), a barcode, or any other form of message presentation that can be transferred or received between two devices. In at least one embodiment, the verifier connection invitation is a network accessible document that can be identified by a link. For example, the verifier connection invitation could be stored on a distributed ledger 112 as a DID document 148 which can be identified by a DID 124d.

Next, at block 406, the verifier agent 145 can provide the verifier connection invitation. In at least one embodiment, the verifier connection invitation can be a matrix barcode (e.g., a QR code) and/or a barcode. In such an embodiment, the verifier agent 145 can direct the verifier computing environment 109 to display the matrix barcode (e.g., QR code) and/or the barcode for consumption by another computing device. In another embodiment where the verifier connection invitation can be a matrix barcode (e.g., a QR code) and/or a barcode, such a matrix barcode and/or barcode can be sent to another computing device. In at least another embodiment, the verifier agent 145 can send the verifier connection invitation to the second computing device. In some embodiments, the verifier connection invitation can be sent over e-mail, SMS messaging, or other messaging protocols. In some embodiments, the verifier connection invitation can be stored on the distributed ledger 112 as a DID document 148. As DID documents 148 can be publicly accessible and they can be referenced by the corresponding DID 124, another computing device can access the verifier connection invitation by retrieving the verifier connection invitation from the distributed ledger.

Continuing to block 409, the verifier agent 145 can receive the fifth packet having a request to establish a secure connection between the verifier agent 145 and the holder agent 142. The verifier agent 145 can receive the fifth packet from a holder agent 142. The request to establish the secure connection can be a request to securely connect the holder agent 142 and the verifier agent 145 in a bi-directional secure connection. The request to establish the secure connection can include a cryptographic key that can be used to generate a shared secret between the holder agent 142 and the verifier agent 145.

Next, at block 412, the verifier agent 145 can receive a sixth packet having a verifiable presentation derived from a verifiable credential 130. The verifier agent 145 can receive the sixth packet over the secure connection that was established at block 409. The sixth packet can be received in response to establishing the secure connection between the holder agent 142 and the verifier agent 145. Verifiable presentations are tamper-evident presentations derived from a verifiable credential 130 encoded in such a way that the source of the data can be trusted after a process of verification. The verifiable presentations are synthesized in such a way that the verifiable credential 130 cannot be recreated from the verifiable presentation alone. Verifiable credentials 130 and verifiable presentations can be implemented using various standards, such as a version of the World Wide Web Consortium's (W3C's) Verifiable credentials data model standard.

Continuing to block 415, the verifier agent 145 can verify the verifiable presentation that was derived from the verifiable credential 130. The verifiable presentation can specify the manner in which the verifiable presentation can be verified. In at least some embodiments, the verifiable presentation can be verified using a zero-knowledge proof. In at least some embodiments, the verifiable presentations can utilize an evidence-based scheme. Various ways of verifying the verifiable presentation are further described in in the World Wide Web Consortium's (W3C's) verifiable credentials data model standard.

At block 418, the verifier agent 145 can send a seventh packet acknowledging the secure connection has been established and the result of verifying the verifiable presentation. To prevent duplicative packets being sent, the combination of acknowledging both the secure connection has been established and the result of verifying the verifiable presentation can be sent as one single packet rather than two distinct packets. Once block 418 has completed, the flowchart of FIG. 4 can come to an end.

Moving on to FIGS. 5A and 5B, shown are sequence diagrams that provides at least one example of the interactions between the issuer agent 139, the holder agent 142, and the verifier agent 145. The sequence diagrams of FIGS. 5A and 5B provide merely an example of the many different types of functional arrangements that can be employed by the issuer agent 139, the holder agent 142, and the verifier agent 145. As an alternative, the sequence diagrams of FIGS. 5A and 5B can be viewed as depicting examples of elements of one or more method implemented within the network environment 100.

Beginning with FIG. 5A, the issuer agent 139 can generate an issuer connection invitation, as previously described in block 203 of FIG. 2. Next, the issuer agent 139 can provide the connection invitation to a holder agent 142, as previously described in block 206 of FIG. 2. The holder agent 142 can obtain the issuer connection invitation from the issuer agent 139, as previously described in block 303 of FIG. 3. The holder agent 142 can send a first packet that requests a verifiable credential 130 and requests that a secure connection be established between the holder agent 142 and the issuer agent 139, as previously described in block 306 of FIG. 3, which the issuer agent can receive, as previously described in block 209 of FIG. 2. The issuer agent 139 can send a second packet that establishes the secure connection between the holder agent 142 and the issuer agent 139, as previously described in block 212 of FIG. 2, which the holder agent 142 can receive, as previously described in block 309 of FIG. 3. Next, the issuer agent 139 can prepare the verifiable credential 130 by generating or retrieving a verifiable credential 130 and signing the verifiable credential 130, as previously described in block 215 of FIG. 2. The issuer agent 139 can send a third packet to the holder agent 142 having the verifiable credential 130, as previously described in block 218 of FIG. 2, which the holder agent 142 can receive, as previously described in block 312 of FIG. 3. The holder agent 142 can send a fourth packet acknowledging that the secure connection has been established and that the verifiable credential 130 has been received, as previously described in block 315 of FIG. 3, which the issuer agent 139 can receive, as previously described in block 221 of FIG. 2.

Continuing with FIG. 5B, the verifier agent 145 can generate a verifier connection invitation, as previously described in block 403 of FIG. 4. The verifier agent 145 can then provide the verifier connection invitation, as previously described in block 406 of FIG. 4, which the holder agent 142 can obtain, as previously described in block 318 of FIG. 3. The holder agent 142 can send a fifth packet that requests that a secure connection is established between the holder agent 142 and the verifier agent 145, as previously described in block 321 of FIG. 3, which the verifier agent 145 can receive, as described in block 409 of FIG. 4. The holder agent 142 can then send a sixth packet having a verifiable presentation derived from the verifiable credential 130, as previously described in block 324 of FIG. 3, which the verifier agent 145 can receive, as previously described block 412 of FIG. 4. The verifier agent 145 can verify the source of the verifiable presentation that was derived from the verifiable credential 130, as previously described in block 415 of FIG. 4. The verifier agent 145 can send a seventh packet acknowledging the secure connection has been established and the result of verifying the verifiable presentation, as previously described at block 418 of FIG. 4, which the holder agent 142 can receive, as previously described in block 327 of FIG. 3. Subsequently, the sequence diagrams of FIGS. 5A and 5B can come to an end.

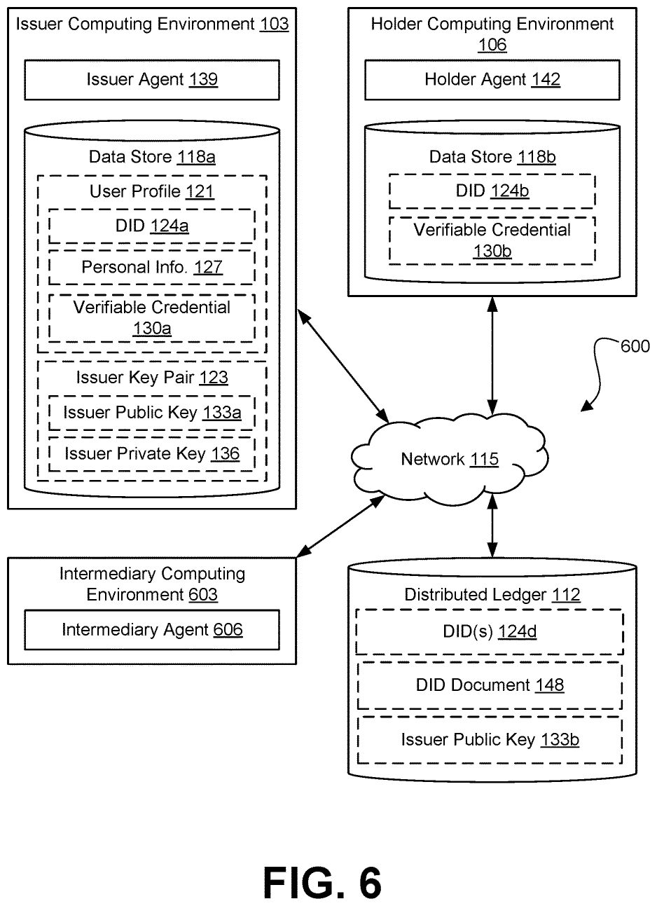

Moving on to FIG. 6, shown is a network environment 600 according to various embodiments of the present disclosure. The network environment 600 can include an issuer computing environment 103, a holder computing environment 106, a distributed ledger 112, and an intermediary computing environment 603, each of which can be in data communication with each other via a network 115. The issuer computing environment 103, the holder computing environment 106, the distributed ledger 112, and the network 115 are each previously described in the discussion of FIG. 1 and retain their descriptions for the purposes of network environment of FIG. 6.

The intermediary computing environment 603 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

In at least one embodiment, the intermediary computing environment 603 can employ a plurality of computing devices that can be arranged in one or more server banks or computer banks or other arrangements. Such computing devices can be located in a single installation or can be distributed among many different geographical locations. For example, the intermediary computing environment 603 can include a plurality of computing devices that together can include a hosted computing resource, a grid computing resource, or any other distributed computing arrangement. In some cases, the verifier computing environment 109 can correspond to an elastic computing resource where the allotted capacity of processing, network, storage, or other computing-related resources can vary over time.

In at least another embodiment, the intermediary computing environment 603 can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a video game console, or other devices with like capability. The intermediary computing environment 603 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the verifier computing environment 109 or can be connected to the intermediary computing environment 603 through a wired or wireless connection.

Various applications or other functionality can be executed in the intermediary computing environment 603. The components executed on the intermediary computing environment 603 include intermediary agent 606, and other applications, services, processes, systems, engines, or functionality not discussed in detail herein.

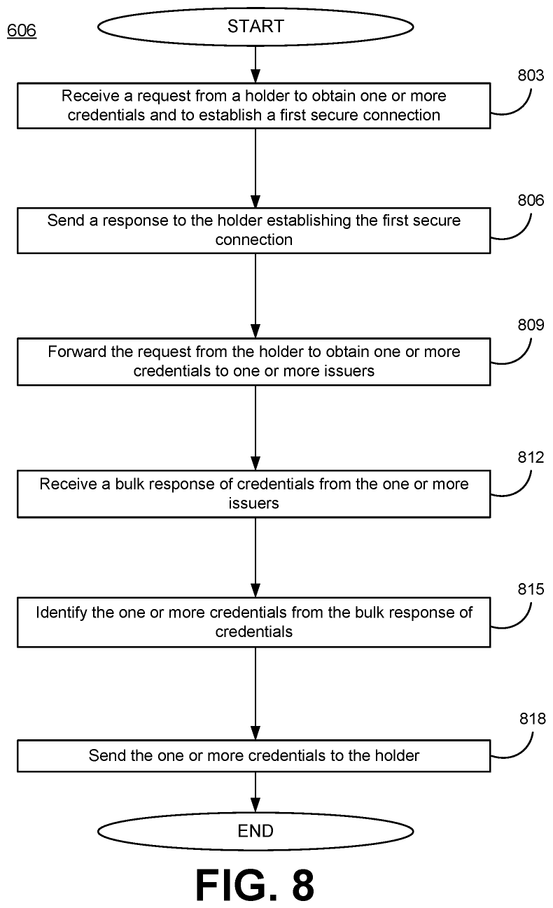

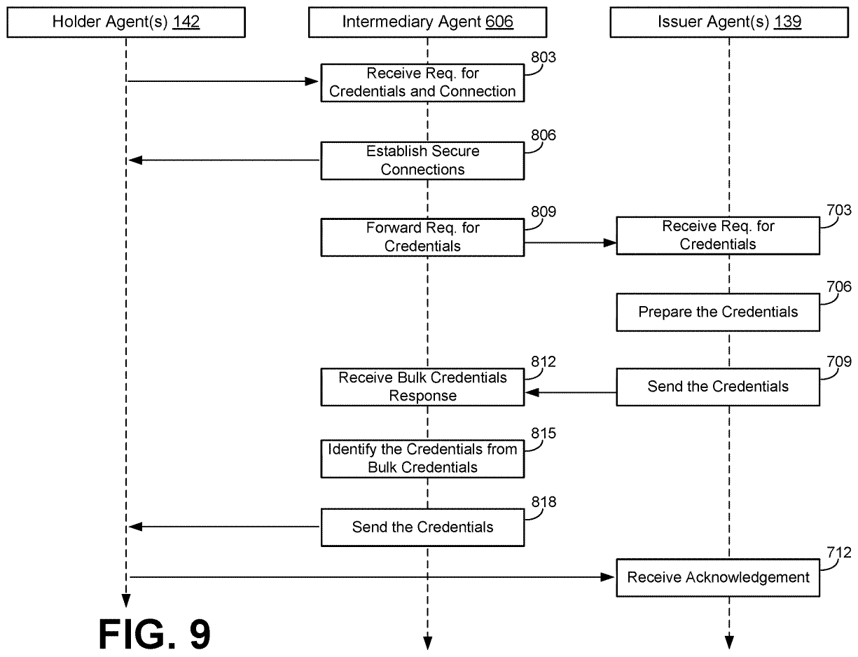

The intermediary agent 606 can be executed to perform various actions. For example, the intermediary agent 606 can receive a request from a holder agent 142 to obtain one or more verifiable credentials 130 and to establish a secure connection between the holder agent 142 and the intermediary agent 606. The intermediary agent 606 can also send a response to the holder agent 142 establishing the secure connection between the holder agent 142 and the intermediary agent 606. The intermediary agent 606 can also forward the request from the holder agent 142 to obtain the one or more verifiable credentials 130 to one or more issuer agents 139. The intermediary agent 606 can also receive bulk responses of verifiable credentials 130 from one or more issuer agents 139. The intermediary agent 606 can also identify the one or more verifiable credentials 130 that correspond to the holder agent 142. The intermediary agent 606 can also send the one or more verifiable credentials 130 to the holder agent 142. Further discussion on the actions that the intermediary agent 606 can be executed to perform will be discussed in FIGS. 8 and 9.

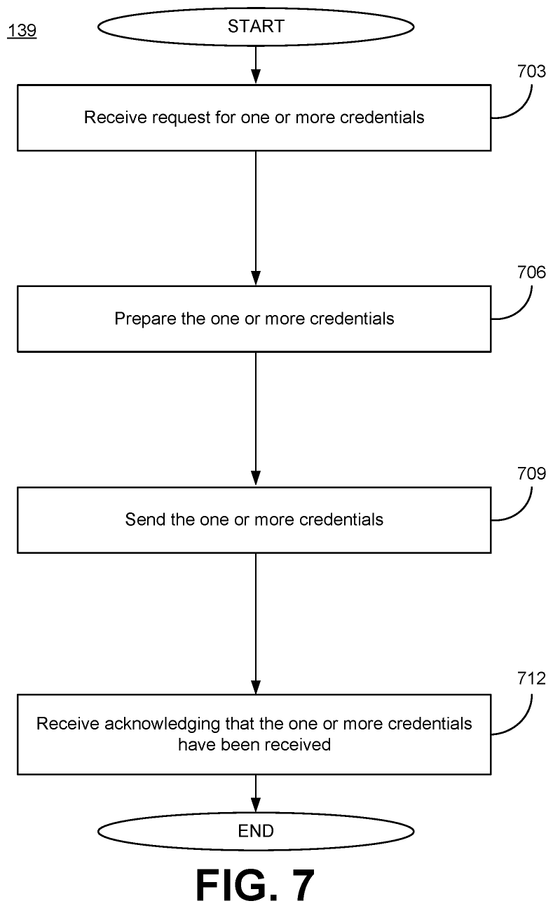

Referring next to FIG. 7, shown is a flowchart that provides one example of the operation of a portion of the issuer agent 139. The flowchart of FIG. 7 provides merely an example of the many different types of functional arrangements that can be employed to implement the operation of the depicted portion of the issuer agent 139. As an alternative, the flowchart of FIG. 7 can be viewed as depicting an example of elements of a method implemented within the network environment 600.

Beginning with block 703, the issuer agent 139 can receive a request for one or more verifiable credentials 130. The request for one or more verifiable credentials 130 can include information that could identify the type of credentials being requested, such as personal info 127 from a user profile 121, one or more specified DIDs 124, or other information that could identify the one or more verifiable credentials 130 to be returned. In at least some embodiments, the request for the one or more verifiable credentials 130 can include credential requests which the issuer agent 139 cannot provide. In such cases, the issuer agent 139 can ignore such credential requests that the issuer agent 139 cannot provide. In at least one embodiment the request for one or more verifiable credentials 130 can be received from an intermediary agent 606. In such an embodiment, means for securely connection the intermediary agent 606 and the issuer agent 139 can be pre-established prior to performing this method and any communications can be presumed to be made over a secure connection. In at least another embodiment, the issuer agent 139 can receive one or more requests for one or more verifiable credentials 130 from one or more holder agents 142 hosted on one or more holder computing environments 106.

Next, at block 706, the issuer agent 139 can prepare the one or more verifiable credentials 130. In some embodiments, one or more verifiable credentials 130 requested might not exist even though it is capable of providing such credential. In such a situation, the issuer agent 139 must generate verifiable credentials 130 that do not exist, as needed. Verifiable credentials 130 can also be stored in a data store 118a. The issuer agent 139 can retrieve one or more verifiable credentials 130 from the data store 118a, as needed. Once each of the one or more verifiable credential 130 that the issuer agent 139 can provide have been generated or retrieved, each of those verifiable credentials 130 can be signed by the issuer private key 136. When the verifiable credential 130 is signed by the issuer private key 136, any other computing device will be able to verify the source of the verifiable credential 130 includes the issuer computing environment 103.

Continuing to block 709, the issuer agent 139 can send the prepared one or more verifiable credentials 130. In at least one embodiment, the issuer agent 139 can send the prepared one or more verifiable credentials 130 to the intermediary agent 606. In at least another embodiment, the issuer agent 139 can send the prepared one or more verifiable credentials 130 to one or more holder agents 142 on one or more holder computing environments 106. In at least one embodiment, the issuer agent 139 can send the one or more verifiable credentials 130 over a secure connection. In at least one embodiment, the issuer agent 139 can send the prepared one or more verifiable credentials 130 in response to the one or more verifiable credentials 130 being prepared at block 706.

At block 712, the issuer agent 139 can receive an acknowledgement that the one or more credentials have been received. In at least one embodiment, the issuer agent 139 can receive the acknowledgement from one or more holder agents 142. In another embodiment, the issuer agent 139 can receive one or more acknowledgements from the intermediary agent 606. In such an embodiment, it may be beneficial for an intermediary agent 606 to send a consolidated acknowledgement to the issuer agent 139 to receive that explains that the respective verifiable credentials 130 have been delivered from the intermediary agent 606 to their respective holder agents 142. Once block 712 has completed, the flowchart of FIG. 7 can come to an end.

Referring next to FIG. 8, shown is a flowchart that provides one example of the operation of a portion of the intermediary agent 606. The flowchart of FIG. 8 provides merely an example of the many different types of functional arrangements that can be employed to implement the operation of the depicted portion of the intermediary agent 606. As an alternative, the flowchart of FIG. 8 can be viewed as depicting an example of elements of a method implemented within the network environment 600.

Beginning with block 803, the intermediary agent 606 can receive a request from a holder agent 142 to obtain one or more verifiable credentials 130 and to establish a secure connection between the holder agent 142 and the intermediary agent 606. The request to establish the secure connection can be a request to securely connect the holder agent 142 and the intermediary agent 606 in a bi-directional secure connection. The request to establish the secure connection can include a cryptographic key that can be used to generate a shared secret between the holder agent 142 and the intermediary agent 606. In at least one embodiment, the request for one or more verifiable credentials 130 can include information that could identify the type of credentials being requested, such as personal info 127 from a user profile 121, one or more specified DIDs 124, or other information that could identify the one or more verifiable credentials 130 to be returned.

Next, at block 806, the intermediary agent 606 can send a response to the holder agent 142 establishing the secure connection between the holder agent 142 and the intermediary agent 606. In at least some embodiments, the intermediary agent 606 can generate a shared secret based at least in part on a cryptographic key sent in the first packet. The shared secret is known by the holder agent 142 and the intermediary agent 606, which can be used for encrypting and/or decrypting in the secure connection between the intermediary agent 606 and the holder agent 142. Once the secure connection has been established, the intermediary agent 606 can acknowledge that the secure connection has been established by sending the response to the holder agent 142. Doing so informs the holder agent 142 that the communications between the intermediary agent 606 and the holder agent 142 are now secure.

Continuing to block 809, the intermediary agent 606 can forward the request from the holder agent 142 to obtain the one or more verifiable credentials 130 to one or more issuer agents 139. The intermediary agent 606 can send the request for one or more verifiable credentials 130 to one or more issuer agents 139, such as a first issuer agent 139, as second issuer agent 139, and so forth. Each issuer agent 139 may not be able to provide each credential in the request, but by providing the request to each of the issuer agents 139 there is a higher probability that the requested credentials can be issued from one of the one or more issuer agents 139. To further consolidate communications, the intermediary agent 606 can consolidate one or more requests from various holder agents 142 into a single request that is sent to each of the issuer agents 139. In doing so, fewer requests are sent between the intermediary agent 606 and the issuer agents 139.

Next, at block 812, the intermediary agent 606 can receive bulk responses of verifiable credentials 130 from one or more issuer agents 139. In response to forwarding the requests for the verifiable credentials 130 to the one or more issuer agents 139, the intermediary agent 606 can receive bulk responses of verifiable credentials 130 from each of the issuer agents 139 that contain zero or more verifiable credentials 130 corresponding to the request.

Continuing to block 815, the intermediary agent 606 can identify the one or more verifiable credentials 130 that correspond to the holder agent 142. Due to the issuer agents 139 sending the verifiable credentials 130 as bulk responses, the requested verifiable credentials 130 need to be identified and separated from other verifiable credentials 130 requested by other holder agents 142. In at least one embodiment, the intermediary agent 606 can identify and separate the verifiable credentials 130 based at least in part on a corresponding DID 124 associated with the holder agent 142. In at least another embodiment, the intermediary agent 606 can introspect the claims being made in the verifiable credential and compare such claims to the information provided in the request for credentials. In some embodiments, the intermediary agent 606 can also sign each of the identified verifiable credentials 130 to indicate that the intermediary agent 606 also verifies the source of the verifiable credentials 130.

At block 818, the intermediary agent 606 can send the one or more verifiable credentials 130 to the holder agent 142. Once block 818 has completed, the flowchart of FIG. 7 can come to an end.

Moving on to FIG. 9, shown is sequence diagram that provides at least one example of the interactions between the issuer agent 139, the holder agent 142, and the intermediary agent 606. The sequence diagram of FIG. 9 provides merely an example of the many different types of functional arrangements that can be employed by the issuer agent 139, the holder agent 142, and the intermediary agent 606. As an alternative, the sequence diagram of FIG. 9 can be viewed as depicting examples of elements of one or more method implemented within the network environment 600.

To begin, the intermediary agent 606 can receive one or more requests from one or more holder agents 142 to obtain one or more verifiable credentials 130 and to establish a secure connection between each of the holder agents 142 and the intermediary agent 606, as previously described in block 803 of FIG. 8. The intermediary agent 606 can then send a response to each respective holder agent 142 establishing the secure connection between the holder agent 142 and the intermediary agent 606, as previously described in block 806 of FIG. 8. The intermediary agent 606 can then forward the request from the holder agents 142 to obtain the one or more verifiable credentials 130 to one or more issuer agents 139, as previously described in block 809 of FIG. 8, which the issuer agent(s) 139 can receive, as previously described in block 703 of FIG. 7. The issuer agent 139 can prepare the one or more verifiable credentials 130, such as generating or retrieving one or more verifiable credentials 130, as previously described in block 706 of FIG. 7. The issuer agent 139 can then send the one or more verifiable credentials 130 to the intermediary agent 606, as previously described in block 709 of FIG. 7, which the intermediary agent 606 can receive, as described in block 812 of FIG. 8. The intermediary agent 606 can identify the one or more verifiable credentials 130 that correspond to each of the holder agents 142, as previously described in block 815 of FIG. 8. The intermediary agent 606 can send the one or more verifiable credentials 130 to the holder agent 142, as previously described in block 818 of FIG. 8. The issuer agent 139 can then receive an acknowledgement that the one or more credentials have been received from either the holder agent(s) 142 or from the intermediary agent 606, as previously described in block 712 of FIG. 7. Subsequently, the sequence diagram of FIG. 9 can come to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) can also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same network environment 100 or network environment 600.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A method, comprising:
receiving, by an intermediary agent from a holder agent, a secure connection request and a request for one or more verifiable credentials corresponding to a decentralized identifier (DID);
sending, by the intermediary agent to the holder agent, an acceptance of the secure connection request;
receiving, by the intermediary agent from an issuer agent, a plurality of verifiable credentials;
identifying, by the intermediary agent, a first verifiable credential from the plurality of verifiable credentials corresponding to the DID; and
sending, by the intermediary agent to the holder agent, at least the first verifiable credential.

2. The method of claim 1, further comprising establishing, by the intermediary agent in response to identifying the first verifiable credential in the plurality of verifiable credentials corresponding to the DID, a secure connection with the holder agent.

3. The method of claim 1, wherein:
the issuer agent is a first issuer agent;
the plurality of verifiable credentials is a first plurality of verifiable credentials; and
the method further comprises:
receiving, by the intermediary agent from a second issuer agent, a second plurality of verifiable credentials; and
identifying, by the intermediary agent, a second verifiable credential from the second plurality of verifiable credentials corresponding to the DID; and
sending, by the intermediary agent to the holder agent, the second verifiable credential.

4. The method of claim 3, further comprising:
generating, by the intermediary agent, a third verifiable credential; and
sending, by the intermediary agent to the holder agent, the third verifiable credential.

5. The method of claim 1, wherein:
the holder agent is a first holder agent;
the DID is a first DID;
the secure connection request is a first secure connection request;
the request for one or more verifiable credentials is a first request for one or more verifiable credentials; and
the method further comprises:
receiving, by the intermediary agent from a second holder agent, a second secure connection request and a second request for one or more verifiable credentials corresponding to a second DID;
sending, by the intermediary agent to the second holder agent, an acceptance of the second secure connection request;
identifying, by the intermediary agent, a second verifiable credential from the plurality of verifiable credentials corresponding to the second DID; and
sending, by the intermediary agent to the second holder agent, at least the second verifiable credential.

6. The method of claim 5, further comprising establishing, by the intermediary agent in response to identifying the second verifiable credential in the plurality of verifiable credentials corresponding to the second DID, a secure connection with the second holder agent.

7. The method of claim 1, further comprising:
signing, by the intermediary agent, the first verifiable credential with a private key of a public-private key pair that is used to uniquely identify the intermediary agent.

8. A system, comprising:
a first computing device comprising a processor and a memory; and
machine-readable instructions stored in the memory that, when executed by the processor, cause the first computing device to at least:
receive, from a second computing device, a secure connection request and a request for one or more verifiable credentials corresponding to a decentralized identifier (DID);
send, to the second computing device, an acceptance of the secure connection request;
receive, from a third computing device, a plurality of verifiable credentials;
identify a first verifiable credential from the plurality of verifiable credentials corresponding to the DID; and
send, to the second computing device, at least the first verifiable credential.

9. The system of claim 8, wherein the machine-readable instructions, when executed by the processor, further cause the first computing device to at least establish, in response to identifying the first verifiable credential in the plurality of verifiable credentials corresponding to the DID, a secure connection with the second computing device.

10. The system of claim 8, wherein:
the plurality of verifiable credentials is a first plurality of verifiable credentials; and
the machine-readable instructions, when executed by the processor, further cause the first computing device to at least:
receive, from a fourth computing device, a second plurality of verifiable credentials;
identify a second verifiable credential from the second plurality of verifiable credentials corresponding to the DID; and
send, to the second computing device, the second verifiable credential.

11. The system of claim 10, wherein the machine-readable instructions, when executed by the processor, further cause the first computing device to at least:
generate a third verifiable credential; and
send, to the second computing device, the third verifiable credential.

12. The system of claim 8, wherein:
the DID is a first DID;
the secure connection request is a first secure connection request;
the request for one or more verifiable credentials is a first request for one or more verifiable credentials; and
the machine-readable instructions, when executed by the processor, further cause the first computing device to at least:
receive, from a fourth computing device, a second secure connection request and a second request for one or more verifiable credentials corresponding to a second DID;
send, to the fourth computing device, an acceptance of the second secure connection request;
identify a second verifiable credential from the plurality of verifiable credentials corresponding to the second DID; and
send, to the fourth computing device, at least the second verifiable credential.

13. The system of claim 12, wherein the machine-readable instructions, when executed by the processor, further cause the first computing device to at least establish, in response to identifying the second verifiable credential in the plurality of verifiable credentials corresponding to the second DID, a secure connection with the fourth computing device.

14. The system of claim 8, wherein the machine-readable instructions, when executed by the processor, further cause the first computing device to at least:
sign the first verifiable credential with a private key of a public-private key pair that is used to uniquely identify the first computing device.

15. A non-transitory computer-readable medium storing instructions that, when executed, cause a processor of a first computing device to at least:
receive, from a second computing device, a secure connection request and a request for one or more verifiable credentials corresponding to a decentralized identifier (DID);
send, to the second computing device, an acceptance of the secure connection request;
receive, from a third computing device, a plurality of verifiable credentials;
identify a first verifiable credential from the plurality of verifiable credentials corresponding to the DID; and
send, to the second computing device, at least the first verifiable credential.

16. The non-transitory computer-readable medium of claim 15, wherein the instructions, when executed by the processor, further cause the first computing device to at least establish, in response to identifying the first verifiable credential in the plurality of verifiable credentials corresponding to the DID, a secure connection with the second computing device.

17. The non-transitory computer-readable medium of claim 15, wherein:
the plurality of verifiable credentials is a first plurality of verifiable credentials; and
the instructions, when executed by the processor, further cause the first computing device to at least:
receive, from a fourth computing device, a second plurality of verifiable credentials;
identify a second verifiable credential from the second plurality of verifiable credentials corresponding to the DID; and
send, to the second computing device, the second verifiable credential.

18. The non-transitory computer-readable medium of claim 17, wherein the instructions, when executed by the processor, further cause the first computing device to at least:
generate a third verifiable credential; and
send, to the second computing device, the third verifiable credential.

19. The non-transitory computer-readable medium of claim 15, wherein:
the DID is a first DID;
the secure connection request is a first secure connection request;
the request for one or more verifiable credentials is a first request for one or more verifiable credentials; and
the instructions, when executed by the processor, further cause the first computing device to at least:
receive, from a fourth computing device, a second secure connection request and a second request for one or more verifiable credentials corresponding to a second DID;
send, to the fourth computing device, an acceptance of the second secure connection request;
identify a second verifiable credential from the plurality of verifiable credentials corresponding to the second DID; and
send, to the fourth computing device, at least the second verifiable credential.

20. The non-transitory computer-readable medium of claim 19, wherein the instructions, when executed by the processor, further cause the first computing device to at least establish, in response to identifying the second verifiable credential in the plurality of verifiable credentials corresponding to the second DID, a secure connection with the fourth computing device.
